(19) United States
(12) Patent Application Publication
(10) Pub. No.: US 2009/0147255 A1
(43) Pub. Date: Jun. 11, 2009

(54) METHOD FOR TESTING A SEMICONDUCTOR DEVICE AND A SEMICONDUCTOR DEVICE TESTING SYSTEM

(76) Inventors: Kent B. Erington, Austin, TX (US); Kristofor J. Dickson, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/952,210

(22) Filed: Dec. 7, 2007

(51) Int. Cl. G01J 3/30

(52) U.S. Cl. 356/318

(57) ABSTRACT

A method for testing a semiconductor device includes irradiating a transistor within the semiconductor device with a light beam, where the irradiating the transistor induces a current within the transistor, and, in response to the irradiating, detecting photon emission from the transistor. A semiconductor device testing system includes a light beam emitter which provides a light beam to a device under test (DUT) to induce a current in the DUT, a filter which receives a photon emission from the DUT and removes from the photon emission a reflected light beam that is reflected from the DUT to provide a filtered photon emission, and a photon detector which detects the filtered photon emission.

### BACKGROUND

1. Field

This disclosure relates generally to semiconductor devices, and more specifically, to testing semiconductor devices.

2. Related Art

When semiconductor devices fail to work properly, failure analysis is performed to determine the cause of the problem. Failure analysis involves functional microprobing of device nodes. This can be performed by many different processes such as e-beam probing, probing of metal interconnects, laser voltage probing and time resolved light emitting microscopy (TRLEM). TRLEM is a preferred method and works well if the supply voltage is high. However, if the supply voltage is small (for example, approximately 1.5 V or less) then the signal generated from the TRLEM may be too small to be detected and failure analysis cannot be performed well. In addition, since TRLEM waveform acquisition techniques require a signal to be integrated over time, testing may be too slow (e.g., 12 hours or more).

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a schematic of a system and device under test in accordance with an embodiment;

FIG. 2 illustrates a view of an inverter in accordance with an embodiment; and

FIG. 3 illustrates waveforms.

### DETAILED DESCRIPTION

A light emitting source, such as a laser, is used to stimulate an optical beam induced current (OBIC) that causes electroluminescence (photons) that are detected. These photons can be detected by separating them from a high intensity background of stimulus photons. When the light emitting source irradiates a transistor, a current is created and a photon can be emitted. By detecting the emitted photon, the state of the transistor and its changing between states can be determined. This information is useful for failure analysis of semiconductor devices.

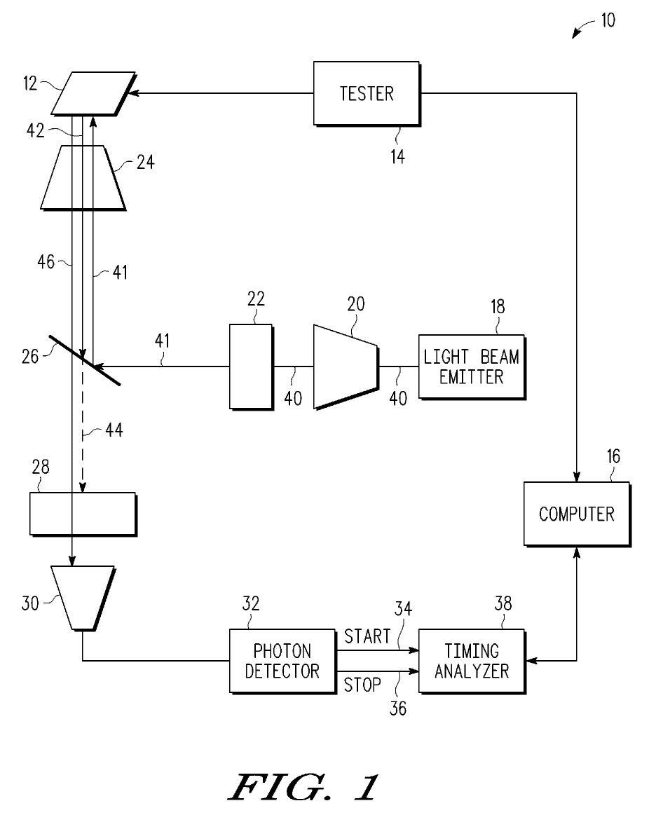

FIG. 1 illustrates a schematic of a system 10 and device under test (DUT) 12 in accordance with an embodiment. In one embodiment, the DUT 12 is a package including one or more integrated circuits. The DUT 12 can be any package type (e.g., a flip chip, a ball grid array, or a quad flat package). During testing, the DUT 12 is powered on.

The system includes a tester 14 coupled to a computer 16 that controls the tester 14. In one embodiment, the computer 16 generates test vectors that are applied to the DUT 12 by the tester 14. In one embodiment, a plurality of test vectors is iteratively executed on the DUT 12. In this embodiment, for each iteration the method(s) of testing described herein may be performed. Hence, the method may be a time resolved method. In another embodiment, described method(s) of testing is (are) performed after a test vector is applied to the DUT 12. Hence, the method may be a static method. For example, during testing, the system can pause on a time vector and a result can be detected, and then the testing can resume in a different area. Because a photon, which is the subject being detected, may not be emitted each time the DUT 12 (or a transistor thereof) is irradiated with light or may not be emitted in the direction of the detector, it may be desirable to perform loops or iterations of test vectors. In one embodiment, the test vector(s) is (are) executed at a speed of greater than one megahertz. This is advantageous over prior art failure analysis approaches where the speed of execution was much less.

The system 10 also includes a light beam emitter 18, a collimator 20, a band pass filter 22, a beam splitter 26 (which may be a diachronic beam splitter), an objective lens 24, a filter 28, a collimator 30, a photon detector 32, and a timing analyzer 38. In one embodiment, these features are incorporated into an infrared microscope. As will be better understood after further discussion, in this embodiment, the microscope can image the DUT 12 and collect a photon emission 46, which is used to perform failure analysis.

When the tester asserts a signal (e.g., a trigger signal), it turns on a photon detector 32. The system 10 may include other features, such as imaging apparatus or features, or shutters. Shutters are a mechanical curtain that can be used to only expose or view a small area of the DUT 12 (e.g., one transistor).

In one embodiment, the light beam emitter 18 is a laser. The laser may be a Nd:YAG laser. The light beam emitter can also be an ultra-high power light source or any other device that emits light. The light beam emitter 18 stimulates the OBIC signal for the DUT 12. More specifically, the light beam emitter 18 generates and emits a light beam 40 that passes through the collimator 20, which aligns the light beam 40 into a parallel beam so that it is neither focused nor divergent. After the light beam 40 passes through the collimator 20, the light beam may pass through the band pass filter 22, which, if present, filters only a predetermined wavelength or predetermined range of predetermined wavelengths to create the excitation light beam 41. In one embodiment, the band pass filter 22 is a laser line filter for 1064 nm wavelength light. In one embodiment, the excitation light beam 41 has energy that is greater than the band gap energy of a semiconductor material (e.g., the channel region) of the transistor being irradiated. The excitation light beam 41 reflects, in one embodiment approximately 90 degrees, off of the beam splitter 26. In one embodiment, the beam splitter 26 is a dichroic beam splitter that reflects approximately 95% of 1064 nm light and transmits light having a wavelength greater than approximately 1100 nm.

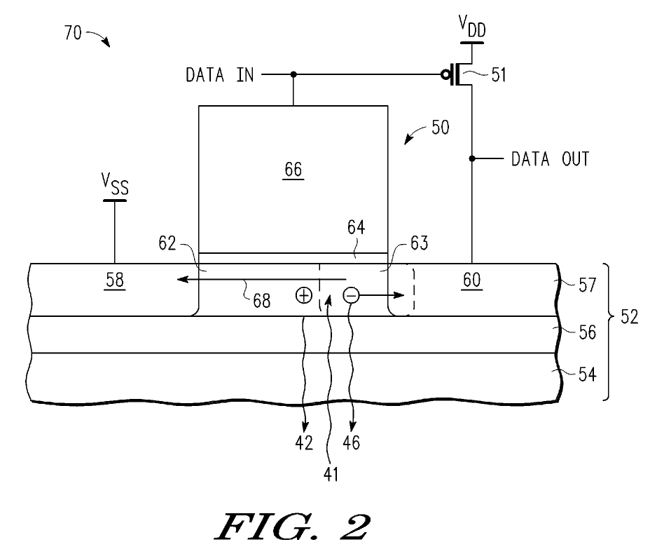

After the excitation light beam 41 is reflected, the excitation light beam 41 travels through the objective lens 24, which focuses the excitation light beam 41 on the DUT 12. Part of the excitation light beam 41 is reflected off of the DUT 12 to form the reflected excitation light beam 42. When the excitation light beam 42 travels through the beam splitter 26 a portion of the reflected excitation light beam 42 may be filtered or prevented from traveling past the beam splitter 26. After the excitation, light beam 42 travels through the beam splitter 26 the excitation light beam 42 becomes an attenuated reflected excitation light beam 44. Light beam 44 is then highly attenuated by optical filter 28. As will be better understood after discussion FIG. 2, when the DUT 12 (e.g., a transistor within the DUT 12) is irradiated with the excitation light beam 41, current is induced and photon emission 46 is generated. In one embodiment, the photon emission 46 includes photons generated due to the excitation light beam 41 and photons that are naturally occurring. In one embodiment, the photon emission 46 also includes photons that are emitted due to the test vectors that are applied. The photon emission 46 travels through the beam splitter 26, the filter 28 and the collimator 30, and is received by the photon detector 32. In one embodiment, the filter 28 is a long pass filter. The filter is used to distinguish the light from the light beam emitter 18, which is the attenuated reflected excitation light beam 44, from the photon emission 46. The filtering can occur by the lights having different energies (wavelength) and filtering the wavelength of the undesired light. In one embodiment, the filter 28 is chosen so that it prevents the passage of light having the same wavelength or range of wavelengths of the light beam emitter 18 or the band pass filter 22, if present. Thus, the filter 28 only allows passage of the light that is a result of the photon emission, not the light that is originally from the light beam emitter 18. Thus, the system 10 differentiates between the incident light (the excitation light beam 41 that is reflected as reflected excitation light beam 42) and the photon emission 46. This is performed in the embodiment illustrated using the filter 28, but other methods can be used to differentiate the light.

In one embodiment, the photon detector 32 is an external detector mounted on an auxiliary port of the system 10. In this embodiment, a CW laser or pulsed laser may be used as the light beam emitter 18. A pulsed laser may be desired for static mapping of logic states as well as for reduction of photon emission noise sources due to sample heating. In one embodiment, the detector is a time-correlated-single-photon-counting (TCSPC) detector or another type of time discriminating detector.

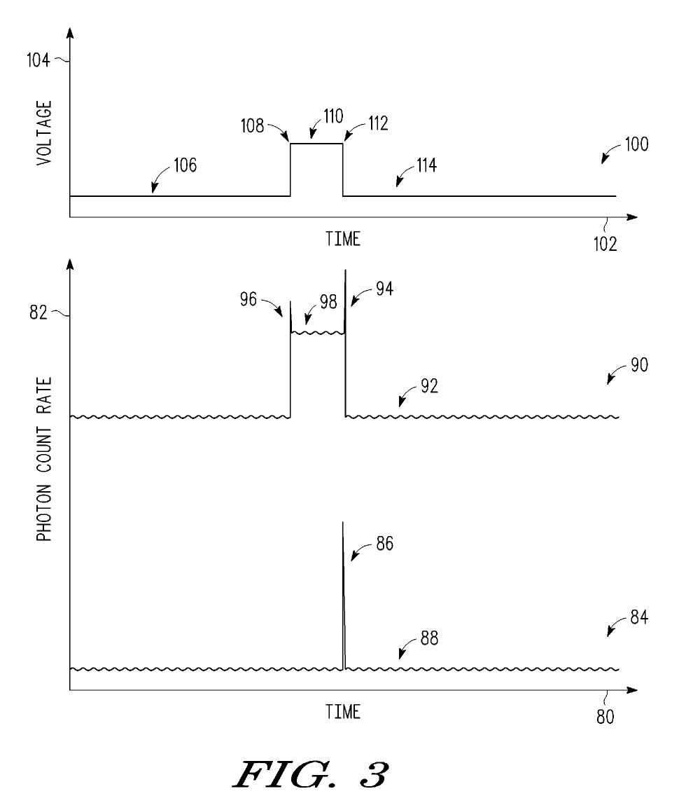

The photon detector 32 sends a start signal 34 to the timing analyzer 38 when the system 10 is turned on and asserts a stop signal 36 when the photon detector 32 receives or detects a photon from the photon emission 46. When the timing analyzer 38 receives the stop signal 36 it updates a histogram. The histogram may be stored or viewed in the computer 16, with the time of the stop signal 36 to create a waveform, which will be better understood after discussion of FIG. 3. In one embodiment, the computer 16 accumulates a photon count over time of the photons, which are detected by the photon detector 32. The timing analyzer 38 is coupled to the computer 16. However, in other embodiments, instead of a waveform other results are generated. For example, the result could be a map of different colors.

In one embodiment, the photon emission 46 is detected while the DUT 12 is irradiated with the excitation light beam 41. In another embodiment, the photon emission 46 is detected after irradiating the DUT 12. In one embodiment, the DUT 12 is irradiated, the irradiating is stopped and then the photon emission 46 is detected.

The photon emission 46 has a different photon energy than the excitation light beam 41. In one embodiment, the wavelength of the photon emission 46 is more than the wavelength of the excitation light beam 41. In one embodiment, the wavelength of the photon emission 46 is less than the wavelength of the excitation light beam 41.

FIG. 2 illustrates a view of an inverter 70 in accordance with an embodiment. The inverter 70 includes an NMOS device 50, illustrated in a cross-sectional view, and a PMOS device 51, illustrated in a schematic view. The NMOS device 50 is coupled to data in node, data out node, the PMOS device 51, which is coupled to Vdd and Vss. When the data in node is high, the data out node is low and vice versa. The NMOS device 50 includes a substrate 52, which in the embodiment illustrated includes a support structure 54, an insulating layer 56 and a semiconductor layer 57. The NMOS device also includes a control electrode (e.g., a gate electrode), a dielectric layer 64 (e.g., a gate dielectric), a source 58, which is coupled to Vss or ground, a drain 60, which is coupled to Vdd through the PMOS transistor 51, and a channel region 62 where a channel is created when the NMOS device 50 is turned on. When the data out node voltage is high, an electric field 63 exists within a portion of the channel region 62 and a portion of the drain 60 as illustrated by the dotted lines.

When the excitation light beam 41 hits the NMOS device 50, some of the excitation light beam 41 is reflected off of surfaces or interfaces. In the embodiment illustrated, the excitation light beam 41 is reflected off the interface between the semiconductor layer 57 and the insulating layer 56 as reflected excitation light beam 42. However, the reflected excitation light beam 42 can be the reflection of the excitation light beam 41 off of any or multiple surfaces or interfaces.

In addition, when the NMOS device 50 is irradiated with the excitation light beam 41, an electron-hole pair is formed as illustrated by the minus and plus signs, respectively, within circles in FIG. 2. During irradiation, when the data out node voltage is set to high, so that the electric field 63 is present and the electron will accelerate to the drain 60, creating the light beam inducted current 68. The drain of the NMOS device 50 is probed during this process. If the data out node voltage is set so that the electric field 63 is greater than a saturated electrical field of the NMOS device 50 then the electron will be a hot electron, which may emit the photon emission 46.

FIG. 3. illustrates a view of waveforms: a prior art photon emission waveform 84 and a photon emission waveform 90, in accordance with an embodiment. The x-axis 80 is the time axis, which in one embodiment may be picoseconds. The y-axis 82 is the photon count rate axis 82. The prior art photon emission waveform 84 is an example of a waveform created using TRLEM. The prior art photon emission waveform 84 includes a high to low drain transition peak 86 and noise 88 that is from the detector and any stray photons naturally created by the system 10. Thus, by using the prior art TRLEM technique it can be determined when the DUT 12 has undergone a high to low drain transition by looking at the high to low drain transition peak 86. However, as explained above, this technique is not useful as the supply voltage decreases for semiconductor devices. When the supply voltage decreases the photo count rate decreases so that the high to low drain transition peak 86 is harder to distinguish from the noise 88.

In contrast, the photon emission waveform 90 can be used with devices having low supply voltages. The photon emission waveform 90 includes noise 92. The noise 92 of the photon emission waveform 90 is illustrated as being greater than the noise 88 of the prior art photon emission waveform 84 since the waveforms are on the same scale. However, a skilled artisan can optimize the process to decrease the noise 92, if desired. The photon emission waveform 90 includes a high to low drain transition peak 94, that is similar to the prior arts high to low drain transition peak 86 since it is located at the same point in time. In addition, the photon emission waveform 90 includes another peak, which was an unexpected benefit. This new peak is a low to high drain transition peak 96. Thus, with the photon emission waveform 90 one can determine when the data in node of the inventor 70 went from low too high and then high to low. In addition, one can determine how long the NMOS device 70 is in the high state.

The waveform 100 illustrates the corresponding voltage applied to data out. The x-axis 102 is the time axis and corresponds to the time axis 80. The y-axis 104 is the voltage axis. During portion 106, data out is low (e.g., “0”) and the NMOS device 50 is at a first state. When the data out switches to high (e.g., “1”), the voltage increases and a transition 108 occurs so that the NMOS device 50 is switched to a second state. Thus portion 110 is when the data out is high and the NMOS device 50 is at the second state. When the data out switches to low, the voltage decreases and a transition 112 occurs so that NMOS device 50 is switched to a third state, which may be the same as the first state as shown in the embodiment illustrated in FIG. 3. During portion 114, the NMOS device 50 is in a third state, which may be the same as the first state. The transitions 108 and 112, which occur when the voltage is changed, correspond to the transitions 94 and 96 of the photon emission waveform 90. Thus, the transitions 94 and 96 indicate presence of a saturation current in a transistor of the DUT 12. The light beam induced emission at the high state 98, which occurs between the transitions 96 and 94, detects a leakage current in a transistor of the DUT 12, where the leakage current is due to the light beam. Thus, by creating the photon emission waveform 90 a state change of a drain of a transistor in the DUT 12 can be detected.

A TRLEM system can be used to detect the photons. However, other systems can be used. For example, non-time resolved systems can be used. The system described should be usable for the 45 nm technology node using SOI substrates. Technology that uses an SOI substrate is more difficult to test. While the industry does not know exactly why SOI substrates are more difficult to test, it is likely due to the electric field around the drain in devices built using an SOI substrate is less (e.g., by a factor of 100) than the electric field around the drain in devices built on bulk substrates (e.g., silicon substrates). For example, laser voltage probing can be used to test devices built on bulk substrates at small geometries, but does not work for devices built on SOI substrates. (The system can be used for logic state mapping.

By now it should be appreciated that there has been provided a method and system for testing a semiconductor device where OBIC current in the device results in emitted photons. This method and system uses a nonpassive method to measure photons of a powered semiconductor device because an OBIC current is generated by irradiating a transistor. Unlike other measurement techniques that can be used for different functions (e.g., Raman spectroscopy), the feature being analyzed (here a semiconductor device) is powered. Hence, a current is present. The method and system described improves the internal signal acquisition for functional debug and failure analysis. Hence, the signal to noise ratio is improved. In one embodiment, this method and system can be used to detect a transmission at 1 gigahertz or more. In one embodiment, this method and system can be used to detect a transmission at greater than 1 megahertz.

Although the invention has been described with respect to specific conductivity types or polarity of potentials, skilled artisans appreciated that conductivity types and polarities of potentials may be reversed. For example, a PMOS transistor can be irradiated instead of an NMOS transistor.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Although the invention is described herein with reference to specific embodiments, various modifications and changes can be made without departing from the scope of the present invention as set forth in the claims below. For example, the NMOS device in FIG. 2 is only one example of a device that can be analyzed. For example, the support structure 54 may not be present. This allows for a shorter wavelength to be used to image and provide the excitation beam 41. In one embodiment where the support structure 54 is not present, a UV wavelength laser is used with the objective lens 24. Benefits may include increased spatial resolution and increased signal to noise improvements due to increased efficiency of the OBIC generation process. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

1. A method for testing a semiconductor device, the method comprising:
irradiating a transistor within the semiconductor device with a light beam, wherein the irradiating the transistor induces a current within the transistor; and
in response to the irradiating, detecting photon emission from the transistor.

2. The method of claim 1, wherein the irradiating the transistor and the detecting the photon emission is performed concurrently.

3. The method of claim 1, wherein the detecting the photon emission is performed after the irradiating the transistor is stopped.

4. The method of claim 1, wherein the detecting the photon emission is performed to indicate presence of a saturation current in the transistor and to detect a leakage current in the transistor due to the light beam.

5. The method of claim 4, wherein the detecting the photon emission comprises detecting a state change of a drain of the transistor.

6. The method of claim 1, wherein the light beam has a wavelength having an energy that is greater than or equal to a band gap of a semiconductor material of the transistor.

7. The method of claim 1, further comprising:
providing one or more test vectors to the semiconductor device, wherein the providing irradiating and the detecting is performed at least partially concurrently with the providing the one or more test vectors.

8. The method of claim 1, further comprising:
in response to the irradiating and prior to the detecting the photon emission, filtering the photon emission to remove a reflected light beam that is reflected from the semiconductor device.

9. A method for testing a semiconductor device, the method comprising:
iteratively executing a plurality of test vectors on the semiconductor device, wherein during each iteration of the executing the plurality of test vectors, the method further comprises:
irradiating a transistor within the semiconductor device with a light beam,
wherein the irradiating the transistor induces a current within the transistor;
detecting photon emission from the transistor; and
accumulating a photon count from the detected photon emission.

10. The method of claim 1, wherein during each iteration of the executing the plurality of test vectors, the method further comprises:
in response to the irradiating and prior to the detecting the photon emission, filtering the photon emission to remove a reflected light beam that is reflected from the semiconductor device.

11. The method of claim 9, wherein after the iteratively executing the plurality of test vectors, using the accumulated photon count to detect a state change of a drain of the transistor.

12. The method of claim 9, wherein the detecting the photon emission is performed to indicate presence of a saturation current in the transistor and to detect a leakage current in the transistor caused by the light beam.

13. The method of claim 9, wherein the light beam has a wavelength having an energy that is greater than or equal to a band gap of a semiconductor material of the transistor.

14. The method of claim 9, wherein the executing the plurality of test vectors is performed at a speed of greater than one megahertz.

15-20. (canceled)

21. The method of claim 7, further comprising: accumulating a photon count from the detected photon emission.

22. The method of claim 21 wherein after the providing one or more test vectors, using the accumulated photon count to detect a stage change of a drain of the transistor.

23. The method of claim 7, wherein the providing one or more test vectors is performed at a speed of greater than one megahertz.

24. The method of claim 7, wherein the providing one or more test vectors comprises iteratively executing a plurality of test vectors wherein during each iteration, the irridating the transistor and the detecting the photon emission occurs.

25. The method of claim 24, where each iteration further comprises accumulating a photon count from the detected protein emission.
